(19) United States
(12) Patent Application Publication
(10) Pub. No.: US 2008/0117729 A1
(43) Pub. Date: May 22, 2008

(54) Optical Disc Apparatus and Laser Driving Method

(76) Inventors: Toshio Satoh, Hitachinaka (JP); Nobuo Nakai, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/858,159

(22) Filed: Sep. 20, 2007

(30) Foreign Application Priority Data
Nov. 16, 2006 (JP) 2006-310618

(51) Int. Cl. G11B 7/00

(52) U.S. Cl. 369/44.23

(57) ABSTRACT

A driving voltage of a laser diode provided in an optical disc apparatus is properly set based on an operating environment thereof to reduce unnecessary power consumption and heat generation. A temperature detector detects the temperature inside a pickup. A memory stores a value of the voltage to be supplied to a laser driver, the voltage corresponding to each of various operating environments. A controller refers to voltage values stored in the memory to set the voltage to be supplied to the laser driver based on a current operating environment. Operating environment parameters includes at least one of the temperature, operation mode, recording rate, and accumulated light emission time. The voltage value to be stored in the memory is a value of the voltage at which electric power consumed by the laser driver becomes smallest in the operating environment.

### CLAIM OF PRIORITY

The present application claims priority from Japanese application serial No. JP2006-310618, filed on Nov. 16, 2006, the content of which is hereby incorporated by reference into this application.

### BACKGROUND OF THE INVENTION

1. Field of the Invention

The present invention relates to an optical disc apparatus for recording/reproducing information to/from an optical disc by use of a laser beam of a semiconductor laser diode, and a laser driving method for properly driving a laser diode.

2. Description of the Related Art

The product development of optical disc apparatuses, each of which is equipped with a BD (Blu-ray Disc) disc whose storage capacity is about 5 times that of a DVD disc, is being stepped up. Although BD discs use a shorter wavelength blue laser beam, the driving voltage of a blue laser diode, which is used as a light source, is higher than that of a red laser diode used for DVD. Accordingly, it is necessary to switch the supply voltage. In particular, if a notebook PC is equipped with a BD disc apparatus, there is a case where the conventional 5 V supply voltage cannot drive the BD disc apparatus. However, increasing the supply voltage to be supplied to the notebook PC as a whole will cause the power consumption and heat generation of the BD disc apparatus to increase. As a result, the operating time is shortened by the limited battery capacity of the notebook PC, or the performance of the BD disc is decreased by the heat generation. They are problems to be solved. Thus, as a technology relating to the use of the blue laser diode whose driving voltage is high, proposals as described below have been made.

JP-A-11-213426 discloses that the laser drive power supply is separated from the power supply of the other sections, and that the laser drive power supply is provided with voltage variable regulator means so as to make the supply voltage of a laser diode output stage variable. In addition, JP-A-2006-185997 discloses that a variable output voltage source is used as the laser drive power supply, and that the variable output voltage source is controlled by operating voltage monitoring means including automatic power control (APC) so that a value of the operating voltage becomes a target value.

### SUMMARY OF THE INVENTION

During the operation of an optical disc apparatus, the optimum driving voltage of a laser diode changes not only when a laser light source is merely switched, but also when an operating environment including the reproduction/recording speed, the environmental temperature, and the laser emission accumulated time changes. In particular, if a blue laser beam used for BD discs is used, the power consumption is large. Therefore, finer adjustment of the driving voltage becomes effective for suppressing unnecessary power consumption and heat generation.

According to the technology disclosed in JP-A-11-213426 described above, a common variable output voltage source is used as the laser drive power supply of two laser diodes (red and blue), and the voltage of the common variable output voltage source is controlled on the basis of a kind of a required laser beam. In other words, the voltage is switched on the basis of a kind of disc (DVD, BD). Therefore, the voltage control based on the operating environment is not taken into consideration.

According to the technology disclosed in JP-A-2006-185997, the operating voltage of the laser drive is so controlled that the operating voltage is kept at a target value. In this case, the settings of the target value are not intended for the reduction of the power consumption and that of the heat generation.

An object of the present invention is to reduce unnecessary power consumption and heat generation of an optical disc apparatus by properly setting the driving voltage of a laser diode of the optical disc apparatus based on an operating environment thereof.

According to one aspect of the present invention, there is provided an optical disc apparatus comprising:

a pickup including a laser diode for emitting a laser beam, and a laser driver for driving the laser diode, the pickup irradiating an optical disc with the emitted laser beam;

a power supply unit which supplies the laser driver with the electric power;

a voltage control unit which controls the voltage to be supplied from the power supply unit to the laser driver;

a temperature detector which detects the temperature inside the pickup; and

a memory which stores a value of the voltage to be supplied to the laser driver, the voltage corresponding to each of various operating environments,

wherein:

the voltage control unit refers to the voltage values stored in the memory to set the voltage to be supplied to the laser driver based on a current operating environment.

Here, operating environment parameters stored in the memory includes at least one of the temperature, an operation mode, the recording rate, and the accumulated light emission time. In addition, the voltage value to be stored in the memory is a value of the voltage at which the electric power consumed by the laser driver becomes smallest in the operating environment.

The voltage control unit includes a PWM control unit, a control voltage generator, and a voltage variable regulator. The PWM control unit transmits, to the control voltage generator, a PWM signal whose duty is equivalent to the voltage to be supplied. The control voltage generator converts the PWM signal into the control voltage, and then transmits the control voltage to the voltage variable regulator. The voltage variable regulator uses the control voltage to adjust the voltage to be supplied to the laser driver.

According to another aspect of the present invention, there is provided a laser driving method comprising the steps of:

storing beforehand, in a memory, a value of the voltage to be supplied to a laser driver, the voltage corresponding to each of various operating environments;

as current operating environment conditions, acquiring at least one of the temperature inside a pickup, an operation mode, the recording rate, and the accumulated light emission time;

referring to the memory, acquiring the voltage that meets the current operating environment conditions; and

supplying the laser driver with the electric power at the acquired voltage.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating one embodiment of a laser driving control system included in an optical disc apparatus according to the present invention;

FIG. 2 is a table illustrating as an example the relationship between each operating environment and the optimum drive voltage that are stored in the information storage unit 1;

FIGS. 3A through 3D are diagrams each illustrating as an example a waveform used for the driving voltage control according to this embodiment; and

FIG. 4 is a flowchart illustrating the flow of a laser driving method according to this embodiment.

### DETAILED DESCRIPTION OF THE EMBODIMENT

An embodiment of the present invention will be described with reference to drawings as below.

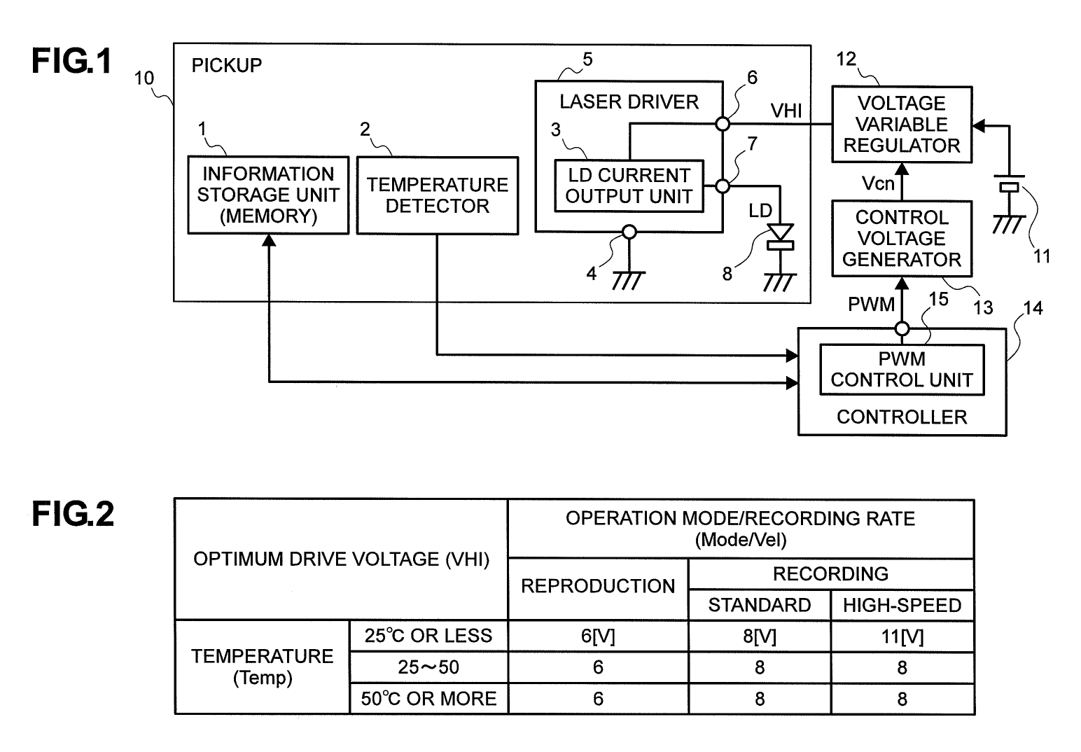

FIG. 1 is a block diagram illustrating one embodiment of a laser driving control system included in an optical disc apparatus according to the present invention. The optical disc apparatus according to this embodiment is equipped with a BD disc, and records or reproduces information by use of a blue laser beam. Although omitted in FIG. 1, a mounted optical disc is rotated by a spindle motor so that a pickup 10 irradiates a recording surface of the optical disc with the laser beam to record or reproduce the information.

The pickup 10 includes a blue laser diode (LD) that is used as a light source 8. The blue laser diode is supplied with the electric power (electric current) from a LD current output unit 3 included in the laser driver 5 so that the blue laser diode emits light. A first power supply 11 supplies the laser driver 5 with the electric power whose voltage is set at a specified value so that light is emitted. A voltage variable regulator 12 adjusts the voltage of the electric power so that the voltage has the optimum value, and then supplies the laser driver 5 with the adjusted voltage. In the laser driver 5, reference numeral 6 denotes a first power supply terminal; reference numeral 7 denotes a LD drive terminal; and reference numeral 4 denotes an earth terminal.

The pickup 10 includes an information storage unit (memory) 1, and a temperature detector 2. The information storage unit 1 is, for example, an EEPROM (electrically rewritable ROM). The information storage unit 1 stores a value of the optimum drive voltage corresponding to each of various operating environments, the optimum drive voltage being used to cause the blue laser diode 8 to emit light. The temperature detector 2 detects the temperature inside the pickup 10.

On the basis of information stored in the information storage unit (memory) 1 and information obtained from the temperature detector 2, the controller 14 sets the driving voltage that is optimum for the laser driver 5. Therefore, a PWM (pulse width modulation) control unit 15 generates a PWM signal that is a control signal; and a control voltage generator 13 converts the PWM signal into the control voltage (Vcn). According to the control voltage, the voltage variable regulator 12 adjusts the output voltage (VHI) to be output to the laser driver 5. Here, the controller 14, the PWM control unit 15, the control voltage generator 13, and the voltage variable regulator 12 control the voltage to be supplied to the laser driver.

FIG. 2 is a table illustrating as an example the relationship between each operating environment and the optimum drive voltage that are stored in the information storage unit 1. Recording/reproduction modes, the recording rate, and the ambient temperature are used as parameters of the operating environments. FIG. 2 illustrates the optimum drive voltage (VHI) to be supplied to the laser driver 5 corresponding to each of the parameters. As shown in the figure, the optimum drive voltage in the recording mode is set at a value higher than that of the optimum drive voltage in the reproducing mode. In addition, with the increase in the recording rate, a value of the optimum drive voltage is increased. On the other hand, with the increase in ambient temperature, the driving voltage is decreased. These tendencies agree with the tendencies of the amount of the optimum light emission power that is set in each operating environment. Besides the above-described parameters, the accumulated light emission time of the laser diode 8, and the like, are also used as parameters. If the accumulated time exceeds a threshold value, it is desirable that the driving voltage be set at a higher value so as to compensate the decrease in the luminous efficiency. FIG. 2 illustrates a case where the BD disc is used (at the time of blue laser light emission). However, a kind of disc can also be used as a parameter so that the settings are made according to the parameter.

When the optimum value of the driving voltage (VHI) is determined, the power consumption and heat generation of the laser driver in each operation mode are measured beforehand by a testing machine with the driving voltage being changed. Then, a driving voltage value at which specified operation can be performed, and at which the power consumption becomes smallest, is determined as the optimum value. In addition, how to compensate the temperature is determined with reference to temperature characteristics of the laser diode. These set values are stored in the information storage unit 1 such as an EEPROM at a point of time at which each optical disc apparatus is shipped. Moreover, if a user wants to change or add an optimum value after the shipment as a result of learning effects, or the like, the user is allowed to write the optimum value to the information storage unit 1 through the controller 15.

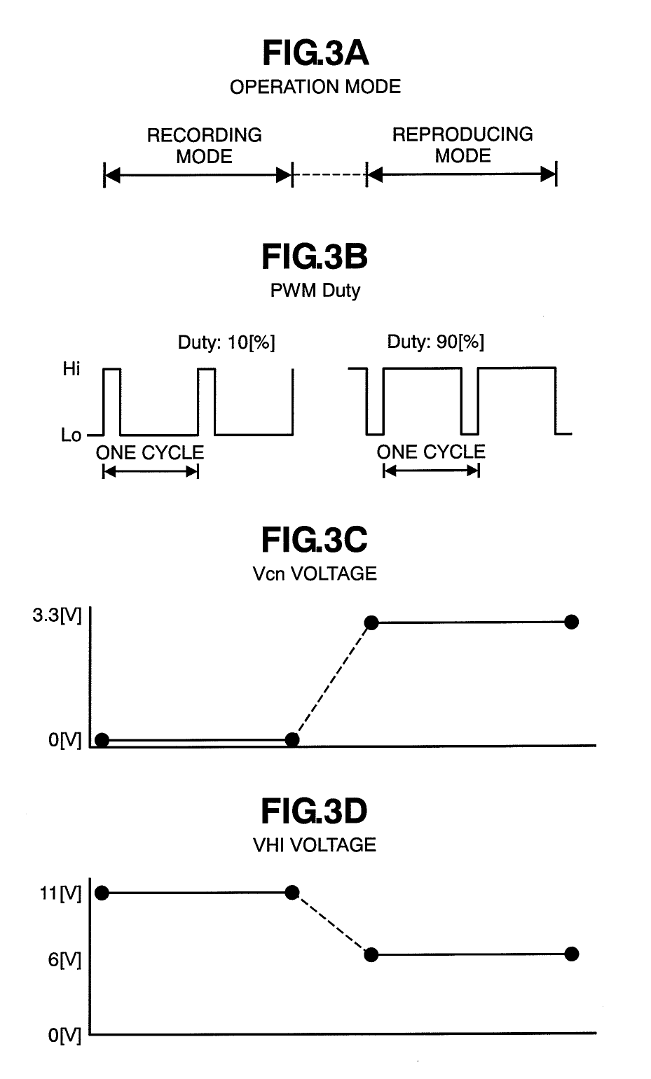

FIGS. 3A through 3D are diagrams each illustrating as an example a waveform used for the driving voltage control according to this embodiment. From the information storage unit 1 and the temperature detector 2, the controller 14 acquires information about a current operating environment (an operation mode, the temperature, and the like), and information about the optimum value of the driving voltage. FIG. 3A is a diagram illustrating operation modes. FIG. 3A illustrates a case where the recording mode is switched to the reproducing mode. FIG. 3B is a diagram illustrating PWM signals generated by the PWM control unit 15. Duty of each PWM signal is changed on a mode basis. In the recording mode, the Duty of the PWM output signal during a Hi period is made shorter (10%). On the other hand, in the reproducing mode, the Duty of the PWM output signal during the Hi period is made longer (90%). FIG. 3C illustrates the control voltage (Vcn) generated by the control voltage generator 13. In the recording mode, the control voltage (Vcn) is set at a low value. On the other hand, in the reproducing mode, the control voltage (Vcn) is set at a high value. FIG. 3D illustrates the driving voltage (VHI) to be supplied to the laser driver 5, the driving voltage (VHI) being output from the voltage variable regulator 12. By setting the driving voltage (VHI) at a high value (11 V) in the recording mode, and by setting the driving voltage (VHI) at a low value (6 V) in the reproducing mode, the driving voltage (VHI) to be supplied to the laser driver 5 is optimized.

Even if other parameters of the operating environment are used (the recording rate, the ambient temperature, the accumulated light emission time, and the like), it is possible to optimally control the driving voltage by changing the Duty of each PWM signal in like manner. As a result, it is possible to minimize the power consumption of the laser driver, and thereby to reduce unnecessary power consumption and heat generation of the laser driver.

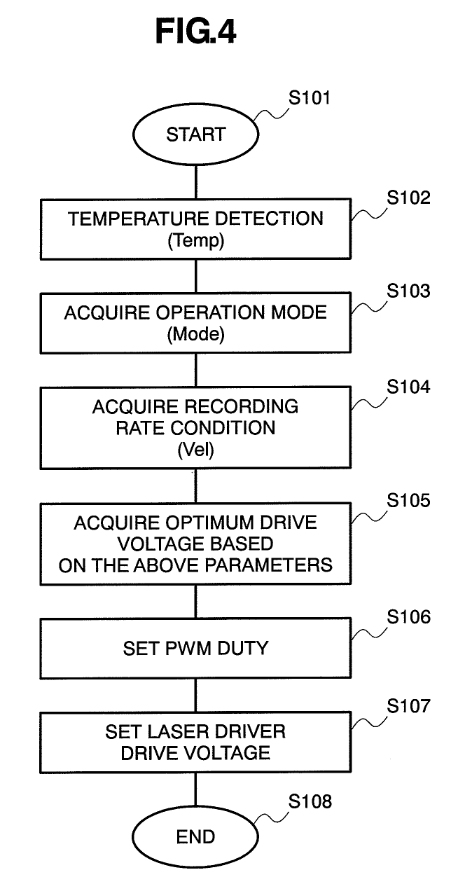

FIG. 4 is a flowchart illustrating the flow of a laser driving method according to this embodiment. On the receipt of an instruction to perform recording operation or reproduction operation, the controller 14 starts settings of laser driving conditions (step S101). First of all, the current temperature (Temp) inside the pickup is detected by the temperature detector 2 (step S102). Next, a kind of an operation mode (Mode) is acquired (step S103), and then recording rate conditions thereof are acquired (step S104). On the basis of the acquired parameter conditions, the optimum drive voltage (VHI) is read out from the information storage unit 1 to acquire the optimum drive voltage (VHI) (step S105). In this case, referring to the table shown in FIG. 2, for example, the temperature (Temp) is compared with a threshold value, and then the optimum value is selected according to temperature classification (high temperature, normal temperature, and low temperature) Also with respect to the operation mode (Mode) and the recording rate, the optimum value corresponding to each of them is selected.

The PWM control unit 15 included in the controller sets the Duty of a PWM signal corresponding to the acquired optimum drive voltage (VHI), and then transmits the Duty to the control voltage generator 13 (step S106). The control voltage generator 13 converts the PWM signal into the control voltage Vcn. The voltage variable regulator 12 optimally sets the driving voltage (VHI) of the laser driver 5 by use of the control voltage Vcn (step S107). As a result, the settings of the driving voltage of the laser driver 5 are completed. The laser driver 5 then drives the laser diode 8 under these conditions to cause the laser diode 8 to emit a laser beam. Subsequently, the process proceeds to specified recording/reproduction operation (step S108).

The above-described settings of the driving voltage of the laser driver 5 can be made not only at the time of initial settings when recording/reproduction operation starts, but also during the recording/reproduction operation. This makes it possible to cope with even a change in operating environment such as an increase in temperature, and to quickly correct the driving voltage. Moreover, although omitted in FIG. 4, it is possible to properly add the accumulated light emission time, a kind of disc, and the like, as operating environment parameters. For the accumulated light emission time, the accumulated time up to the current time is kept stored in the information storage unit 1 so that the accumulated time is compared with a threshold value. Further, when the kind of disc is handled, a kind of a mounted disc is identified by a disc identification unit, which is not illustrated, and thereby the optimum value corresponding to the kind of disc is selected. As a result, it is possible to make finer voltage settings.

As described above, according to this embodiment, it is possible to optimally set the laser driving voltage corresponding to a change in operating environment. Therefore, it is possible to reduce unnecessary power consumption and heat generation of the laser driver. In this case, the optimum value of the laser driving voltage corresponding to each operating environment is stored in the memory beforehand, and the settings are made with reference to the optimum value. Therefore, it is possible to quickly perform the control, and to simplify the control system.

According to the present invention, even if an operating environment of an optical disc apparatus changes, it is possible to cope with the change, and to reduce unnecessary power consumption and heat generation of the optical disc apparatus.

While we have shown and described an embodiment in accordance with our invention, it should be understood that the disclosed embodiment is susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disc apparatus for irradiating an optical disc with a laser beam to record/reproduce information to/from an optical disc, the optical disc apparatus comprising:
a pickup including a laser diode for emitting a laser beam, and a laser driver for driving the laser diode, the pickup irradiating the optical disc with the emitted laser beam;
a power supply unit which supplies the laser driver with the electric power;
a voltage control unit which controls a voltage to be supplied from the power supply unit to the laser driver;
a temperature detector which detects the temperature inside the pickup; and
a memory which stores a value of the voltage to be supplied to the laser driver, the voltage corresponding to each of various operating environments,
wherein:
the voltage control unit refers to the voltage values stored in the memory to set the voltage to be supplied to the laser driver based on a current operating environment.

2. The optical disc apparatus according to claim 1, wherein operating environment parameters stored in the memory includes at least one of the temperature, an operation mode, a recording rate, and accumulated light emission time.

3. The optical disc apparatus according to claim 1, wherein the voltage value to be stored in the memory is a value of the voltage at which the electric power consumed by the laser driver becomes smallest in the operating environment.

4. The optical disc apparatus according to claim 1, wherein:
the voltage control unit includes a PWM control unit, a control voltage generator, and a voltage variable regulator;
the PWM control unit transmits, to the control voltage generator, a PWM signal whose duty is equivalent to the voltage to be supplied;
the control voltage generator converts the PWM signal into the control voltage, and then transmits the control voltage to the voltage variable regulator; and
the voltage variable regulator uses the control voltage to adjust the voltage to be supplied to the laser driver.

5. A laser driving method used when an optical disc is irradiated with a laser beam to record/reproduce information to/from the optical disc, the method comprising the steps of:
storing beforehand, in a memory, a value of the voltage to be supplied to a laser driver, the voltage corresponding to each of various operating environments;
as current operating environment conditions, acquiring at least one of the temperature inside a pickup, an operation mode, a recording rate, and accumulated light emission time;
referring to the memory to acquire the voltage that meets the current operating environment conditions; and
supplying the laser driver with the electric power at the acquired voltage.
